(19) United States
(12) Patent Application Publication
(10) Pub. No.: US 2022/0094388 A1
(43) Pub. Date: Mar. 24, 2022

(54) MODULATOR, DEMODULATOR AND WIRELESS COMMUNICATION SYSTEM

(71) Applicant: Shanghai Panchip Microelectronics Co., Ltd., Shanghai (CN)

(72) Inventors: Weiwei KAN, Shanghai (CN); Chuan WU, Shanghai (CN)

(73) Assignee: Shanghai Panchip Microelectronics Co., Ltd., Shanghai (CN)

(21) Appl. No.: 17/423,446

(22) PCT Filed: Oct. 10, 2020
(86) PCT No.: PCT/CN2020/120246

§ 371 Date: Jul. 15, 2021

(30) Foreign Application Priority Data
Nov. 11, 2019 (CN) 201911092651.7

(51) Int. Cl. H04B 1/69; H04L 27/20; H04L 27/22

(52) U.S. Cl. CPC H04B 1/69; H04B 2001/6912; H04L 27/22; H04L 27/20

(57) ABSTRACT

The embodiment of the invention provides a modulator, which comprises: a channel coding module for carrying out channel coding on data needing to be sent; a m-ary digital phase modulation module which is used for carrying out modulation mapping on the data which is subjected to channel coding and for obtaining corresponding phase data; a differential phase modulation module which is used for modulating the phase data into an initial phase; and a chirp signal generation module which is used for generating a target chirp signal according to the initial phase. By adopting the modulator to generate the target chirp signal, and initial phase can be obtained, the problem of phase ambiguity can be solved, and the chirp signal can be modulated, transmitted, received, and demodulated more accurately.

### BACKGROUND OF THE INVENTION

### 1. Field of the Invention

The invention relates to the technical field of communication, and more particularly, to a modulator, a demodulator and a wireless communication system.

### 2. Description of the Related Art

In the digital communication system, the binary or m-ary modulation of a communication signal is accomplished by changing the amplitude, the phase, or the frequency of the signal in the signal symbol period. For an AM amplitude modulation signal, the amplitude is modulated, while for a FM amplitude modulation signal, the frequency is modulated. A chirp is a spread spectrum modulation signal in which the frequency varies monotonically with time according to specific laws, and it belongs to a frequency modulation signal.

Chirp modulation was applied to communications in 1962. It expresses modulation information at different chirp rates within the same signal symbol period. This technology is mainly applied to sonar and radar. In this case, for a successful measurement of a long-distance and time-retention resolution, the radar needs short-term pulse waves and continuous transmission of signals, and the chirp modulation can retain characteristics of the continuous signals and the pulses. Radar positioning technology can increase the RF pulse width, increase the communication distance, increase the average transmission power, and keep enough signal spectrum width without reducing the range resolution of the radar.

In the existing m-ary chirp keying modulation method, due to the fact that the initial phase of the carrier of the received signal is unknown, the phase of the received signal is ambiguous, it is impossible to estimate the initial phase of the transmitted signal, thus it is impossible to determine m-ary modulation data sent before.

### SUMMARY OF THE INVENTION

Objects of an embodiment of the invention are to solve the problem of the phase ambiguity of a received signal, and to achieve the transmission modulation and receiving modulation of a m-ary chirp signal.

For the above-mentioned objects, the invention provides a modulator, wherein the modulator sends a plurality of original up chirp signals and a plurality of original down chirp signals before sending a target chirp signal, for frequency synchronization and symbol synchronization of the target chirp signal at a receiving demodulator end, wherein when a slope of the target chirp signal is greater than 0, the target chirp signal is an up chirp signal; when a slope of the target chirp signal is less than 0, the target chirp signal is a down chirp signal; the up chirp signal with an initial phase of 0 is the original up chirp signal, the down chirp signal with an initial phase of 0 is the original down chirp signal; wherein the modulator comprises: a channel coding module for carrying out channel coding on data to be sent; a m-ary phase modulation module for carrying out modulation mapping on the data which is subjected to channel coding and for obtaining corresponding phase data; a differential phase modulation module for modulating the phase data into the initial phase; and a chirp signal generation module for generating the target chirp signal based on the initial phase.

Optionally, the modulator is further connected to a radio frequency (RF) module and a power amplifier module in sequence and is configured to output the target chirp signal to the RF module and the power amplifier module.

Optionally, a range of frequencies of the target linear frequency modulation signal is associated with a bandwidth of a transmitted signal.

Optionally, the length of time of the target chirp signal is determined by a spreading factor of the target chirp signal.

Accordingly, the present invention further provides a demodulator, configured to receive the target chirp signal transmitted via the above-mentioned modulator, and configured to demodulate the target chirp signal, the demodulator comprises: a chirp signal synchronous module, configured to receive the plurality of original up chirp signals and the plurality of original down chirp signals, and configured to estimate frequency deviation and symbol deviation of the original up chirp signals and the original down chirp signals for eliminating the frequency deviation and synchronizing symbols of the target chirp signal; a parameter control module for providing the bandwidth and the spreading factor of the target chirp signal; a local chirp generation module, configured to generate a local original down chirp signal based on the bandwidth and the spreading factor of the target chirp signal, and configured to obtain a product signal based on the local original down chip signal and the original up chirp signal; an initial phase computation module, configured to accumulate the product signal, and configured to compute the initial phase of the target chirp signal; a differential phase demodulation module for carrying out differential demodulation on the initial phase of the target chirp signal; a m-ary digital phase demodulation module for carrying out demodulation mapping on the initial phase of the target chirp signal which is subjected to the differential demodulation; and a channel decoding module for reconstructing the target chirp signal.

Optionally, the demodulator further comprises a residual decimal frequency deviation elimination module for eliminating the impact of the frequency deviation on the phase demodulation.

Optionally, the residual decimal frequency deviation elimination module comprises: comparing the phase subjected to the phase demodulation and the phase subjected to the demodulation mapping to obtain a difference value, so that a phase deviation is obtained; carrying out filter integration on the phase deviation to obtain a decimal frequency for a receiving demodulation system, and feeding the obtained decimal frequency back to a frequency mixer module after the decimal frequency passes through the target chirp signal synchronous module.

Accordingly, the invention further provides a wireless communication system comprises any one of the modulators and any one of the demodulators.

The advantages of the invention, in comparison to the prior art, are as follows:

by adopting the modulator to generate the target chirp signal, the initial phase can be obtained, the problem of phase ambiguity can be solved, and the chirp signal can be modulated, transmitted, received, and demodulated more accurately.

### BRIEF DESCRIPTION OF THE DRAWINGS

FIG. 1 is a schematic diagram of a wireless communication terminal according to an embodiment of the invention;

FIG. 2 is an instantaneous frequency diagram of an original up chirp signal;

FIG. 3 is an instantaneous frequency diagram of an original down chirp signal; and

FIG. 4 is a graph of a simulation result from a comparison of the transmission rate sensitive performance in a demodulation system and in a convention way according to an embodiment of the invention.

### DETAILED DESCRIPTION

In the existing m-ary chirp keying modulation method, due to the fact that the initial phase of the carrier of the received signal is unknown, the phase of the received signal is ambiguous, it is impossible to estimate the initial phase of the transmitted signal, thus it is impossible to determine m-ary modulation data sent before.

By adopting the modulator to generate the target chirp signal, the initial phase can be obtained, the problem of phase ambiguity can be solved, and the chirp signal can be modulated, transmitted, received, and demodulated more accurately.

In order to make the above-mentioned objects, features and advantageous effects become more apparent, certain exemplary embodiments according to the present disclosure will be described with reference to the accompanying drawings.

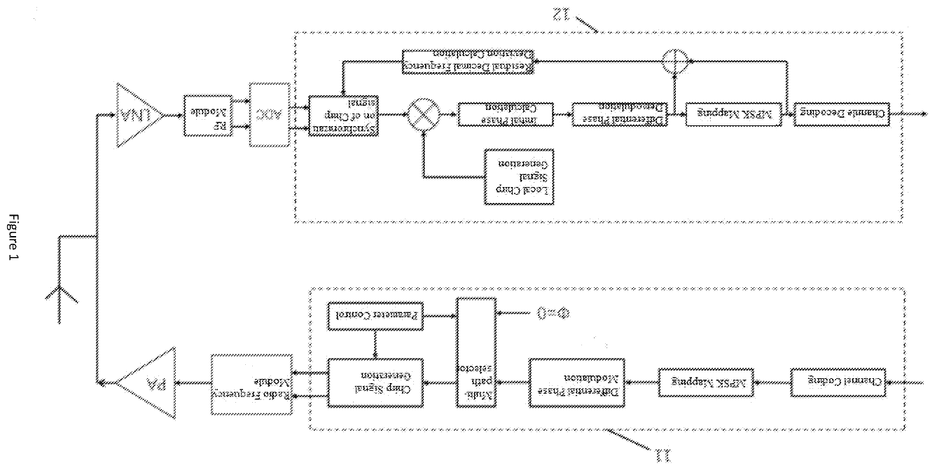

With reference to FIG. 1, the invention provides a wireless communication system comprising a modulator 11 and a demodulator 12. The modulator 11 and the demodulator 12 will be described in more details hereinafter.

In an embodiment, the modulator 11 is suitable for generating a target chirp signal. In this embodiment, the modulator 11 comprises: a channel coding module for carrying out channel coding on data to be sent; a m-ary digital phase modulation module for carrying out modulation mapping on the data which is subjected to channel coding and for obtaining corresponding phase data.

In this embodiment, as shown in the table below, QDPSK (Single Carrier Four Phase Differential Phase Shift Keying) modulation is used to group data bits into 2 bits, quaternary phase keying modulation is mapped, and mapping is performed by using 4PSK according to the input 2 bits to obtain corresponding phase data.

| b (2k − 1) | b (2k) | Φ (k) |
|---|---|---|
| 0 | 0 | π/4 |
| 0 | 1 | 3 π/4 |
| 1 | 0 | −π/4 |
| 1 | 1 | −3 π/4 |

In this embodiment, the modulator further comprises a differential phase modulation module for modulating the phase data into the initial phase.

After the phase data is subjected to phase differential modulation, an initial phase of each up chirp signal is obtained. In particular, first of all, the channel coding module performs channel coding on data to be sent; carrying out modulation mapping on the data which is subjected to channel coding and obtaining corresponding phase data; modulating the phase data into the initial phase.

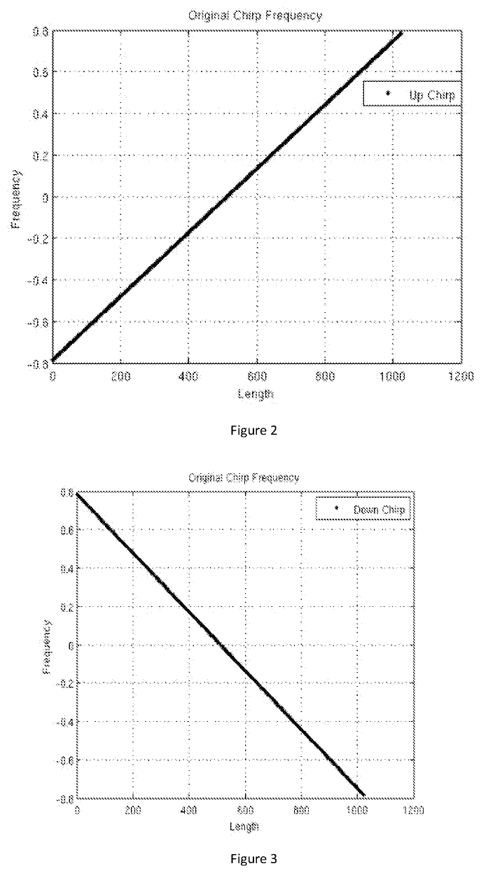

The phase data chirp signal generation module generates a modulation chirp signal according to the initial phase information, slope information, and so on. The initial phase is defined as ϕ=0. When μ>0, the chirp signal is the original up chirp signal, and when μ<0, the chirp signal is the original down chirp signal. FIG. 2 is the original up chirp signal, and FIG. 3 is the original down chirp signal.

The chirp signal generation module generates a chirp signal based on the specified bandwidth (BW) and spreading factor (SF). The chirp signal has a start frequency and an end frequency. The chirp signal also varies linearly in a time period defined by the spreading factor, wherein the chirp signal can be expressed as:

$$s ( t ) = a ( t ) cos ( 2 π {f}_{s} t + 2 πμ {t}^{2} + ϕ ) , - \frac{T}{2} \leq t < \frac{T}{2}$$

a(t) is the envelop of the chirp signal, fₛ is the center frequency of the carrier, T is the duration of the chirp signal, T=2^{SF}Tₛ, wherein Tₛ is the sampling time of the chirp signal. P is the slope of the chirp signal, and it is defined as

$$\vert μ \vert = \frac{BW}{T} .$$

When μ>0, the frequency linearly increases, and it is an up chirp signal; when μ<0, the frequency linearly decreases, and it is a down chirp signal. ϕ is the initial phase of the chirp signal.

In this embodiment, the modulator sends a plurality of original up chirp signals and a plurality of original down chirp signals before sending a target chirp signal, for frequency synchronization and symbol synchronization of the target chirp signal at a receiving demodulator end.

The modulator is further coupled to a radio frequency (RF) module and a power amplifier module for outputting the target chirp signal to the RF module and the power amplifier module. In this embodiment, the chirp signal generation module outputs a baseband signal. I component and Q component of the baseband signal are converted into desired transmission frequency by the RF module, and are amplified by the power amplifier, and are transmitted via antenna.

FIG. 1 shows a schematic diagram of a demodulator 12 according to an embodiment of the invention.

The demodulator comprises a chirp signal synchronous module, an initial phase computation module, a differential phase demodulation module, an MPSK demapping module, a channel decoding module, a residual decimal frequency deviation elimination module, and the like. First of all, the signal is received from the antenna, then it is converted into a baseband signal through a low-noise amplifier (LNA), a down-conversion module, an analog-digital converter (ADC) and other modules; the baseband signal is then processed by the digital baseband demodulator; finally, the sent digital signal is reconstructed. The chirp signal synchronous module estimates frequency deviation and symbol deviation of the chirp signal based on the received plurality of original up chirp signals and the received plurality of original down chirp signals, thereby eliminating the frequency deviation and synchronizing symbols of the target chirp signal. Then the local chirp generation module generates a local original down chirp signal based on the signal bandwidth and the spreading factor and other parameters provided by the parameter control module, and the local original down chirp signal is multiplied by the received modulated up chirp signal to obtain a product signal. The initial phase calculation module accumulates the multiplied product signal within the symbol time period of the chirp signal, and then sends the calculation results of the I component and Q component of the baseband signal to the phase calculation unit to estimate the phase of the baseband signal, that is, the initial phase of the chirp signal is received. The differential phase demodulation module carries out differential decoding on the estimated initial phase of the chirp signal. The MPSK demapping module then performs demapping according to MPSK. The residual decimal frequency deviation elimination module compares the differential phase and the determination result subjected to the demodulation mapping to obtain a difference value, so that a phase deviation is obtained; carrying out filter integration on the phase deviation to obtain a decimal frequency for a receiving demodulation system, thereby eliminating the impact of the residual decimal frequency deviation on the phase demodulation. In addition, data subjected to the demapping process can be restructured the sent data by the channel decoding module, wherein the sent data is modulated by the transmitting end.

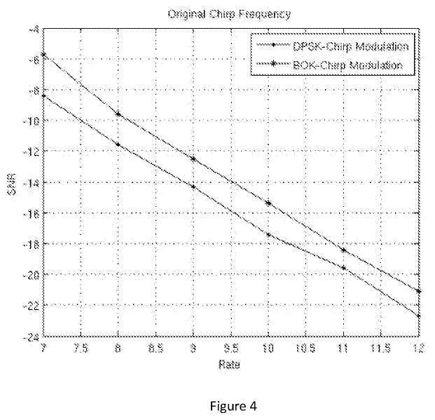

FIG. 4 is a graph of a simulation result from a comparison of the transmission rate versus the Signal-to-Noise Ratio (SNR) in a chirp demodulation system in a simulation embodiment of the invention and that in the conventional chip demodulation system. It can be seen that the performance of the chirp demodulation system by using QDPSK is better than that of the conventional chirp demodulation system at the same transmission rate. Therefore, it proves that this embodiment is effective.

The above descriptions are only the preferred embodiments of the invention, not thus limiting the embodiments and scope of the invention. Those skilled in the art should be able to realize that the schemes obtained from the content of specification and drawings of the invention are within the scope of the invention.

1. A modulator, wherein the modulator sends a plurality of original up chirp signals and a plurality of original down chirp signals before sending a target chirp signal, for frequency synchronization and symbol synchronization of the target chirp signal at a receiving demodulator end, wherein
when a slope of the target chirp signal is greater than 0, the target chirp signal is an up chirp signal; when a slope of the target chirp signal is less than 0, the target chirp signal is a down chirp signal;
the up chirp signal with an initial phase of 0 is the original up chirp signal, the down chirp signal with an initial phase of 0 is the original down chirp signal;
wherein the modulator comprises:
a channel coding module for carrying out channel coding on data to be sent;
a m-ary digital phase modulation module for carrying out modulation mapping on the data which is subjected to channel coding and for obtaining corresponding phase data;
a differential phase modulation module for modulating the phase data into the initial phase; and
a chirp signal generation module for generating the target chirp signal based on the initial phase.

2. The modulator of claim 1, wherein the modulator is further connected to a radio frequency (RF) module and a power amplifier module in sequence and is configured to output the target chirp signal to the RF module and the power amplifier module.

3. The modulator of claim 1, wherein a range of frequencies of the target chirp signal is associated with a bandwidth of a transmitted signal.

4. The modulator of claim 1, wherein the length of time of the target chirp signal is determined by a spreading factor of the target chirp signal.

5. A demodulator, configured to receive the target chirp signal transmitted via the modulator of claim 1, and configured to demodulate the target chirp signal, the demodulator comprises:
a chirp signal synchronous module, configured to receive the plurality of original up chirp signals and the plurality of original down chirp signals, and configured to estimate frequency deviation and symbol deviation of the original up chirp signals and frequency deviation and symbol deviation of the original down chirp signals, for eliminating the frequency deviation and synchronizing symbols of the target chirp signal;
a parameter control module for providing the bandwidth and the spreading factor of the target chirp signal;
a local chirp generation module, configured to generate a local original down chirp signal based on the bandwidth and the spreading factor of the target chirp signal, and configured to obtain a product signal based on the local original down chip signal and the original up chirp signal;
an initial phase computation module, configured to accumulate the product signal, and configured to compute the initial phase of the target chirp signal;
a differential phase demodulation module for carrying out differential demodulation on the initial phase of the target chirp signal;
a m-ary digital phase demodulation module for carrying out demodulation mapping on the initial phase which is subjected to the differential demodulation; and
a channel decoding module for reconstructing the target chirp signal.

6. The demodulator of claim 5, further comprises: a residual decimal frequency deviation elimination module for eliminating the impact of the frequency deviation on the phase demodulation.

7. The demodulator of claim 6, wherein the residual decimal frequency deviation elimination module comprises: comparing the phase subjected to the phase demodulation and the phase subjected to the demodulation mapping to obtain a difference value, so that a phase deviation is obtained; carrying out filter integration on the phase deviation to obtain a decimal frequency for a receiving demodulation system, and feeding the obtained decimal frequency back to a frequency mixer module after the decimal frequency passes through the target chirp signal synchronous module.

8. A wireless communication system comprising a modulator and demodulator, wherein
the modulator sends a plurality of original up chirp signals and a plurality of original down chirp signals before sending a target chirp signal, for frequency synchronization and symbol synchronization of the target chirp signal at a receiving demodulator end, wherein
when a slope of the target chirp signal is greater than 0, the target chirp signal is an up chirp signal; when a slope of the target chirp signal is less than 0, the target chirp signal is a down chirp signal;
the up chirp signal with an initial phase of 0 is the original up chirp signal, the down chirp signal with an initial phase of 0 is the original down chirp signal;
wherein the modulator comprises:
a channel coding module for carrying out channel coding on data to be sent;
a m-ary digital phase modulation module for carrying out modulation mapping on the data which is subjected to channel coding and for obtaining corresponding phase data;
a differential phase modulation module for modulating the phase data into the initial phase; and
a chirp signal generation module for generating the target chirp signal based on the initial phase;
the demodulator is configured to receive the target chirp signal transmitted via the modulator, and is configured to demodulate the target chirp signal, the demodulator comprises:
a chirp signal synchronous module, configured to receive the plurality of original up chirp signals and the plurality of original down chirp signals, and configured to estimate frequency deviation and symbol deviation of the original up chirp signals and frequency deviation and symbol deviation of the original down chirp signals, for eliminating the frequency deviation and synchronizing symbols of the target chirp signal;
a parameter control module for providing the bandwidth and the spreading factor of the target chirp signal;
a local chirp generation module, configured to generate a local original down chirp signal based on the bandwidth and the spreading factor of the target chirp signal, and configured to obtain a product signal based on the local original down chip signal and the original up chirp signal;
an initial phase computation module, configured to accumulate the product signal, and configured to compute the initial phase of the target chirp signal;
a differential phase demodulation module for carrying out differential demodulation on the initial phase of the target chirp signal;
a m-ary digital phase demodulation module for carrying out demodulation mapping on the initial phase which is subjected to the differential demodulation; and
a channel decoding module for reconstructing the target chirp signal.

9. The wireless communication system of claim 8, wherein the modulator is further connected to a radio frequency (RF) module and a power amplifier module in sequence and is configured to output the target chirp signal to the RF module and the power amplifier module.

10. The wireless communication system of claim 8, wherein a range of frequencies of the target chirp signal is associated with a bandwidth of a transmitted signal.

11. The wireless communication system of claim 8, wherein the length of time of the target chirp signal is determined by a spreading factor of the target chirp signal.

12. The wireless communication system of claim 8, further comprises: a residual decimal frequency deviation elimination module for eliminating the impact of the frequency deviation on the phase demodulation.

13. The wireless communication system of claim 12, wherein the residual decimal frequency deviation elimination module comprises: comparing the phase subjected to the phase demodulation and the phase subjected to the demodulation mapping to obtain a difference value, so that a phase deviation is obtained; carrying out filter integration on the phase deviation to obtain a decimal frequency for a receiving demodulation system, and feeding the obtained decimal frequency back to a frequency mixer module after the decimal frequency passes through the target chirp signal synchronous module.
